(19) United States
(12) Patent Application Publication
(10) Pub. No.: US 2010/0192381 A1
(43) Pub. Date: Aug. 5, 2010

(54) FOLDING KNIFE WITH BLADE OPEN ASSISTING FUNCTION

(75) Inventor: Kimiyuki Sakai, Seki-shi (JP)

Correspondence Address: Workman Nydegger;1000 Eagle Gate Tower, 60 East South Temple, Salt Lake City, UT, 84111, US

(73) Assignee: GERBER SAKAI CO., LTD., Seki-shi (JP)

(21) Appl. No.: 12/364,313

(22) Filed: Feb. 2, 2009

(51) Int. Cl. B26B 1/04

(52) U.S. Cl. 30/160

(57) ABSTRACT

A folding knife includes a handle and a blade pivotally supported on the handle. A tang of the blade includes a cam surface. The cam surface has a substantially arcuate guiding portion and an engagement portion that is formed continuously from one end of the guiding portion. The handle has a blade locking mechanism. The locking mechanism includes a slider and a coil spring that biases the slider. The slider is movable along the longitudinal direction of the handle between a lock position, at which the slider is engaged with the engagement portion, and an unlock position, at which the slider is separate from the engagement portion. The slider has a pressing portion that is engaged with the blade when the blade is arranged at the folded position. By moving the slider in the direction from the lock position toward the unlock position when the blade is at the folded position, the pressing portion presses the blade out of the folded position toward the open position.

### BACKGROUND OF THE INVENTION

The present invention relates to a folding knife that has blade open assisting function for assisting pivotal movement of a blade from a folded position to an open position performed by a user using one hand.

An ordinary folding knife includes a handle and a blade pivotally supported at the distal end of the handle. The blade is movable between a folded position (non-use position), in which the blade is received within a receiving groove of the handle, and an open position (use position), in which the blade extends out of the handle. Some of such folding knives have blade open assisting function to assist pivotal movement of the blade from the folded position to the open position performed by the user with one hand. Although various types of these folding knives with blade open assisting function have been proposed and used conventionally, there still is a demand for a knife that is manipulated more easily and has a simpler configuration.

### SUMMARY OF THE INVENTION

Accordingly, it is an objective of the present invention to provide a novel and improved folding knife with blade open assisting function.

To achieve the above objective, a folding knife according to the present invention includes a handle, a blade attached to the handle, a slider supported by the handle so as to be movable along the longitudinal direction of the handle, and a bias member. The blade is capable of pivoting about a pivot axis defined in the handle. The blade is movable between a folded position, at which the blade is received in the handle, and an open position, at which the blade extends from the handle. The blade includes a tang that is located in the handle when the blade is arranged at the open position. A cam surface is provided on an outer peripheral edge of the tang. The cam surface has a substantially arcuate guiding portion extending about the pivot axis and an engagement portion formed continuously from one end of the guiding portion. The slider includes a manipulating portion projecting from the handle and an engaging portion engageable with the cam surface. The slider is movable between a lock position and an unlock position. When the slider is arranged at the lock position, the engaging portion is engaged with the engagement portion so as to lock the blade at the open position. When the slider is located at the unlock position, the engaging portion is spaced from the engagement portion to allow the blade to move from the open position. The bias member biases the slider in a direction from the unlock position toward the lock position. The engaging portion of the slider has a pressing portion that is engaged with the blade when the blade is located at the folded position. When the slider is moved in a direction from the lock position toward the unlock position with the blade held at the folded position, the pressing portion presses the blade out of the folded position toward the open position.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings;

FIG. 1 is a front view of a folding knife according to one embodiment of the present invention, with the blade in an open position;

FIG. 2 is a plan view of the knife in FIG. 1;

FIG. 3 is an exploded perspective view of in FIG. 1; and

FIGS. 4 to 6 are front cross-sectional views sequentially representing blade opening operation of the knife illustrated in FIG. 1.

### DETAILED DESCRIPTION OF THE PREFERRED EMBODIMENTS

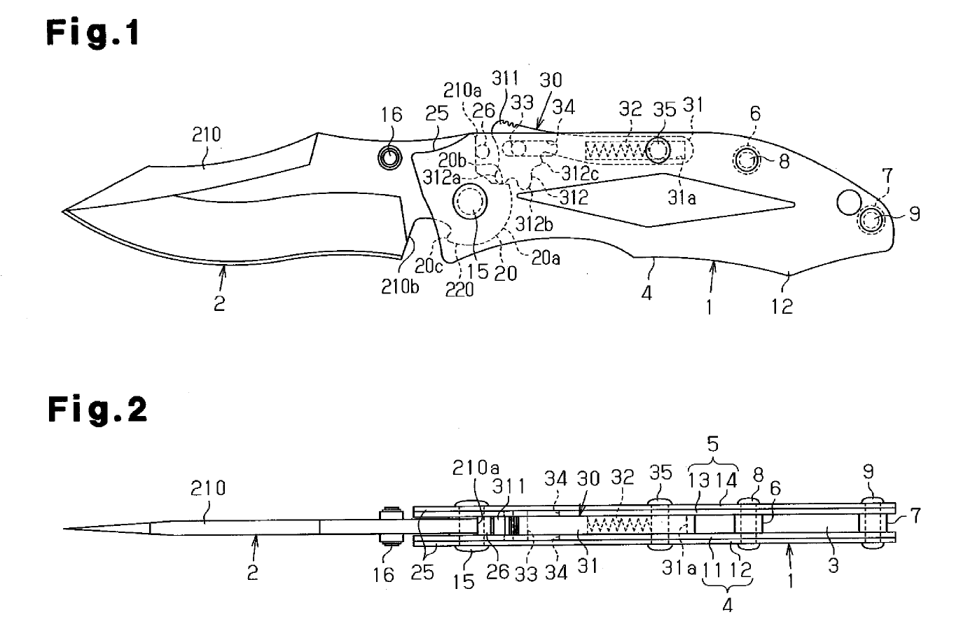

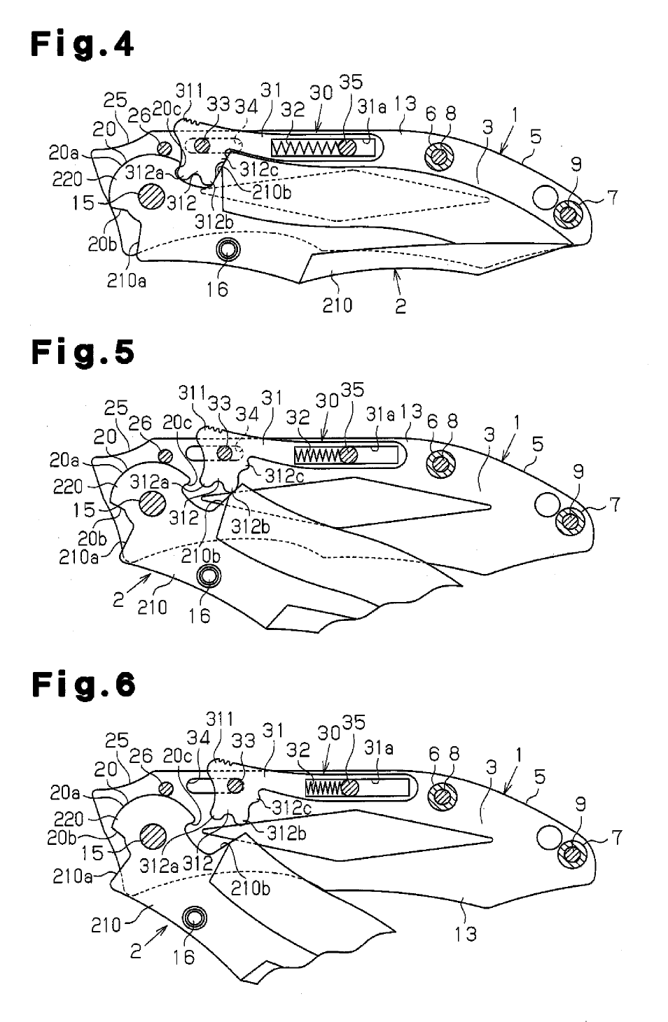

One embodiment of the present invention will now be described with reference to the attached drawings. As shown in FIGS. 1 to 6, a folding knife with blade open assisting function includes a handle 1 and a blade 2, which is pivotally attached to the distal portion of the handle 1. The blade 2 is movable between a folded position (see FIG. 4), in which the blade is received within a receiving groove 3 of the handle 1, and an open position, (see FIG. 1) in which the blade extends out of the handle 1. The folded position corresponds to a non-use position of the blade 2 and the open position corresponds to a use position of the blade 2.

The handle 1 has first and second sidewalls 4 and 5, which are spaced apart at a predetermined interval. First and second spacer members 6 and 7, each of which is formed of metal in a cylindrical shape, are provided between the two sidewalls 4, 5 in the vicinity of the basal portion of the handle 1. The two sidewalls 4 and 5 are joined together by first and second coupling pins 8 and 9 with the spacer members 6, 7 held between the sidewalls 4 and 5. Each of the first and second coupling pins 8 and 9 extends through the corresponding spacer member 6, 7 and the sidewalls 4, 5. The receiving groove 3 is defined between the sidewalls 4, 5, which are spaced apart by the spacer members 6, 7. The first sidewall 4 has a liner plate 11 and an outer plate 12 arranged on the outer side of the liner plate 11. Similarly, the second sidewall 5 has a liner plate 13 and an outer plate 14 arranged on the outer side of the liner plate 13. The two liner plates 11, 13 are preferably formed of metal material. Although the two outer plates 12, 14 are also formed of metal material, the outer plates 12, 14 may be formed of synthetic resin material or wooden material.

A blade shaft 15 extends through the two sidewalls 4 and 5 at the distal portion of the handle 1. The blade 2 has a blade portion 210 and a tang 220, which is formed at the basal portion of the blade portion 210. The tang 220 is pivotally supported by the blade shaft 15. The axis of the blade shaft 15 is the pivot axis of the blade 2 and extends in a direction orthogonal to the handle 1 and the blade 2. The tang 220 is always arranged inside the handle 1 and held by the two liner plates 11 and 13 from both sides. A knob 16 extends from both sides of the blade portion 210 in the vicinity of the basal portion of the blade portion 210. A user may pivot the blade 2 from the folded position to the open position by operating the knob 16 with his or her finger or by pulling the part of the blade 2 exposed from the handle 1 with his or her fingers. The knob 16 may extend only from one side of the blade portion 210.

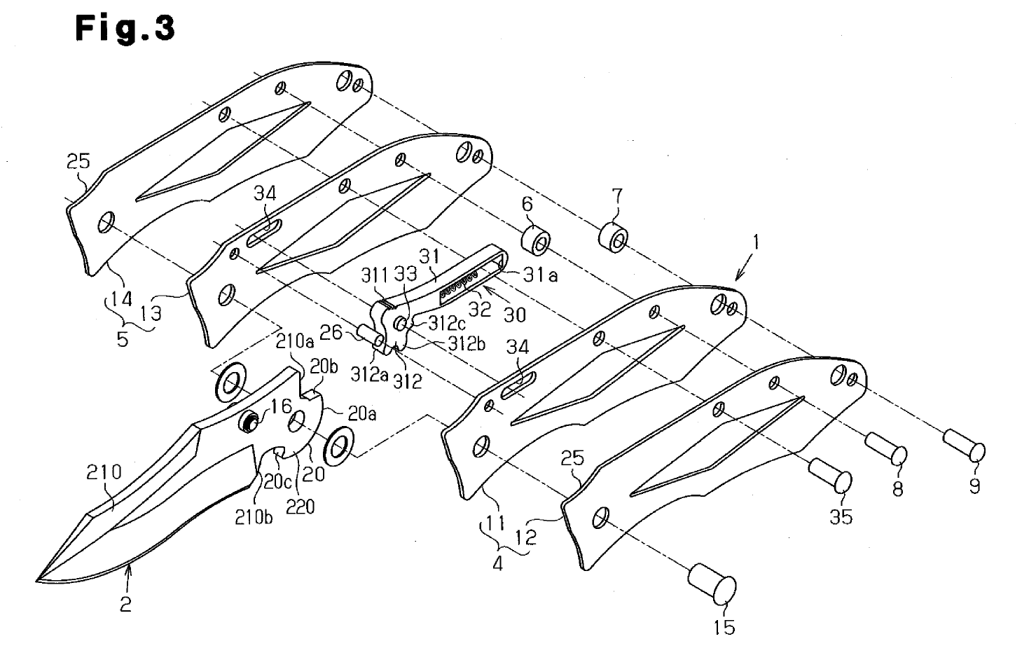

As shown in FIGS. 3 to 6, the peripheral edge of the tang 220 forms a cam surface 20. The cam surface 20 includes an arcuate guiding portion 20a extending about the axis of the blade shaft 15 and a first engagement portion 20b that extends continuously from a first end of the guiding portion 20a. The first engagement portion 20b linearly extends from the first end of the guiding portion 20a toward the distal end of the blade 2. The cam surface 20 further includes a second engagement portion 20c that extends continuously from a second end of the guiding portion 20a. The second engagement portion 20c has a substantially chin-shape and extends from the second end of the guiding portion 20a toward the axis of the blade shaft 15.

As illustrated in FIGS. 1 to 6, the handle 1 has a spine (an upper edge portion) extending between the distal portion and the basal portion of the handle 1. A recessed curved portion, or a finger guiding portion 25, is formed in a portion of the spine in the vicinity of the distal portion. A stopper pin 26 extends between the two sidewalls 4, 5 in the vicinity of the finger guiding portion 25. Both ends of the stopper pin 26 are fitted in holes formed in the corresponding liner plates 11, 13. A first contact portion 210a, which is engageable with the stopper pin 26, is formed in the vicinity of the basal portion of the blade 2, or, specifically, in the basal portion of the blade portion 210 closer to the spine. With reference to FIG. 1, when the blade 2 is pivoted to the open position, the first contact portion 210a becomes engaged with the stopper pin 26 to prevent the blade 2 from pivoting beyond the open position.

A blade locking mechanism 30 is provided between the stopper pin 26 and the first spacer member 6 of the handle 1. The blade locking mechanism 30 locks the blade 2 at the open position and has blade open assisting function for assisting pivotal movement of the blade 2 from the folded position to the open position performed by the user using one hand. In other words, the blade locking mechanism 30 functions also as a blade open assisting mechanism.

The locking mechanism 30 has a metal slider 31, which serves as a manipulating member, and a coil spring 32 serving as a bias member. The slider 31 is arranged between the first and second sidewalls 4, 5 in a manner movable along the longitudinal direction of the handle 1. A guide pin 33 is provided in the vicinity of the first end (the distal end) of the slider 31. The guide pin 33 extends from both side surfaces of the slider 31. An elongated guide hole 34 is defined in each of the liner plates 11, 13 to receive the corresponding one of the two ends of the guide pin 33. The guide pin 33 is movable along the guide holes 34 together with the slider 31.

The slider 31 has an elongated hole 31a, or a receiving hole, which extends from the longitudinal center to the second end (the basal end) of the slider 31. The coil spring 32 is received in the elongated hole 31a. A guide pin 35, which extends to pass through the elongated hole 31a, is attached to the handle 1. The coil spring 32 is arranged between the guide pin 35 and the inner wall of one end of the elongated hole 31a in a compressed state. This arrangement causes the coil spring 32 to constantly bias the slider 31 toward the distal end of the handle 1 (to the left as viewed in FIG. 1). The guide pin 35 functions as a spring seat.

A manipulating portion 311, which projects upward from between the two sidewalls 4, 5 with respect to the handle 1, and an engaging portion 312 projecting toward the blade 2 are provided at the first end of the slider 31. The user can move the slider 31 against the biasing force of the coil spring 32 by manipulating the manipulating portion 311 with a finger. The engaging portion 312 has a lock projection 312a engageable with the cam surface 20 of the tang 220 and first and second pressing projections 312b and 312c, which are engageable with the basal portion of the blade portion 210 closer to the blade edge, which is a second contact portion 210b. The projections 312a, 312b, 312c have smooth arcuate outlines.

When the blade 2 is arranged at the open position, the slider 31 is movable between a lock position, shown in FIG. 1, and an unlock position, shown in FIG. 6, to which the slider 31 retreats from the lock position. When the slider 31 is located at the lock position of FIG. 1, the engaging portion 312 (specifically, the lock projection 312a) of the slider 31 is engaged with the first engagement portion 20b of the tang 220, and as a result, the blade 2 is locked at the open position. When the slider 31 is located at the unlock position shown in FIG. 6, the engaging portion 312 of the slider 31 is disengaged from the first engagement portion 20b, and as a result, the blade 2 is permitted to pivot from the open position to the folded position (see FIG. 4). The coil spring 32 biases the slider 31 in a direction from the unlock position toward the lock position.

FIG. 4 shows a state in which the blade 2 is arranged at the folded position. In this state, the slider 31 is located at the lock position and the engaging portion 312 of the slider 31 is engaged with the second engagement portion 20c of the tang 220 and the second contact portion 210b of the blade portion 210. Specifically, the lock projection 312a of the engaging portion 312 is engaged with the second engagement portion 20c of the tang 220, and the first and second pressing projections 312b and 312c of the engaging portion 312 are engaged with the second contact portion 210b of the blade portion 210. The second pressing projection 312c is arranged at a position closer to the blade edge, or more spaced from the pivot axis of the blade 2, than the first pressing projection 312b. The engagement of the engaging portion 312 of the slider 31 and the blade 2 prevents the blade 2 from pivoting beyond the folded position. The coil spring 32 biases the slider 31 in the direction from the unlock position toward the lock position, or to the left as viewed in FIG. 4. This causes the lock projection 312a of the slider 31 to press the second engagement portion 20c and apply pivoting force to the blade 2 in a counterclockwise direction as viewed in FIG. 4. Accordingly, the blade 2 is securely held in the folded position shown in FIG. 4 and does not accidentally pop out from the receiving groove 3.

With the blade 2 held at the folded position illustrated in FIG. 4, the user holds the handle 1 with one hand and manipulates the manipulating portion 311 with a finger of the same hand so as to move the slider 31 from the lock position to the unlock position against the biasing force of the coil spring 32. This causes the first and second pressing projections 312b, 312c of the slider 31 to press the second contact portion 210b of the blade portion 210, thus applying pivoting force to the blade 2 in a clockwise direction as viewed in FIG. 4. As a result, the blade 2 is pushed out of the folded position shown in FIG. 4 toward the open position, as shown in FIG. 5.

The second pressing projection 312c is located at a position closer to the blade edge, or more spaced from the pivot axis of the blade 2, than the first pressing projection 312b. Accordingly, at an initial stage of manipulation of the slider 31 by the user, the second pressing projection 312c presses the second contact portion 210b at a position relatively spaced from the pivot axis of the blade 2. The user thus can move the blade 2 with relatively small force. When the second pressing projection 312c is separated from the second contact portion 210b, the first pressing projection 312b is also moved away from the pivot axis of the blade 2. In this state, the first pressing projection 312b presses the second contact portion 210b. As a result, also in this case, the user can move the blade 2 with relatively small force.

When the user shakes the knife while holding the handle 1 with the blade 2 pushed out as illustrated in FIG. 5, the blade 2 is swung out and pivots to the open position shown in FIG. 1 via the state illustrated in FIG. 6. In this state, the first contact portion 210a of the blade portion 210 contacts the stopper pin 26 and thus the blade 2 is prevented from pivoting beyond the open position. If the user releases the manipulating portion 311 of the slider 31 while the blade 2 is pivoting toward the open position, the slider 31 moves to the lock position due to the biasing force of the coil spring 32. Accordingly, when the blade 2 reaches the open position illustrated in FIG. 1, the lock projection 312a of the slider 31 is engaged with the first engagement portion 20b of the tang 220. As a result, the blade 2 is locked at the open position with respect to the handle 1.

In this manner, the blade open assisting function of the locking mechanism 30 is brought out through manipulation of the slider 31 by the user, allowing the locking mechanism 30 to assist pivotal movement of the blade 2 from the folded position to the open position performed by the user using one hand. Alternatively, as has been described, with the blade 2 held at the folded position illustrated in FIG. 4, the user can pivot the blade 2 from the folded position to the open position by manipulating the knob 16 with a finger of one hand while holding the handle 1 with the same hand, or by pulling the portion of the blade 2 exposed from the handle 1 with fingers of one hand while holding the handle 1 with the other hand.

In the state shown in FIG. 1, when force is applied to the blade 2 in the direction toward the folded position (the counterclockwise direction as viewed in FIG. 1), the first engagement portion 20b of the tang 220 is pressed against the lock projection 312a of the slider 31, and thus the blade 2 is prevented from pivoting. As a result, the blade 2 is reliably maintained in the locked state.

In a state where the blade 2 is locked at the open position illustrated in FIG. 1, the blade 2 is unlocked when the user manipulates the manipulating portion 311 with a finger to move the slider 31 toward the unlock position against the biasing force of the coil spring 32. In other words, by moving the slider 31 from the lock position of FIG. 1 to the unlock position of FIG. 6 through manipulation, the lock projection 312a of the slider 31 is separated from the first engagement portion 20b. As a result, the blade 2 is allowed to pivot from the open position toward the folded position. Accordingly, by pivoting the blade 2 in the counterclockwise direction as viewed in FIG. 1 when the slider 31 is held at the unlock position, the blade 2 is moved to the folded position of FIG. 4 via the above-described states of FIGS. 6 and 5.

The present embodiment described above has the following advantages.

The blade locking mechanism 30 is constructed simply using a relatively small number of components including the slider 31 and the coil spring 32. Operation of the blade locking mechanism 30 is also relatively simple. Thus, the manufacturing cost is reduced and there is little possibility for defects to occur in the locking mechanism 30.

The blade locking mechanism 30 has not only the function of locking the blade 2 at the open position but also the blade open assisting function for assisting pivotal movement of the blade 2 from the folded position to the open position performed by a user using one hand. Specifically, when the user holds the handle 1 by one hand and manipulates the slider 31 with a finger of the same hand, the slider 31 operates to press the blade 2 out of the folded position toward the open position. As a result, simply by shaking the knife while manipulating the slider 31, the user can easily move the blade 2 from the folded position to the open position with one hand. Since such blade open assisting function is achieved without adding any dedicated components separately from the locking mechanism 30, the configuration is simplified and the manufacturing cost is reduced.

The engaging portion 312 of the slider 31 has the first pressing projection 312b and the second pressing projection 312c. The second pressing projection 312c is arranged at the position more spaced from the pivot axis of the blade 2 than the first pressing projection 312b. Accordingly, when the slider 31 is manipulated by the user, the blade 2 can be pressed by the engaging portion 312 of the slider 31 at a portion of the blade 2 maximally spaced from the pivot axis. The blade 2 is thus pivoted to the open position with relatively small force.

The handle 1 has the finger guiding portion 25 for guiding a finger of the user. The finger guiding portion 25 is arranged in the vicinity of the manipulating portion 311 of the slider 31. By placing a finger on the finger guiding portion 25 and moving the finger along the finger guiding portion 25, the user is allowed to manipulate the manipulating portion 311 easily and smoothly.

The embodiment of the present invention may also be modified as follows.

The shape of the slider 31 is not restricted to the illustrated shape but may be modified as necessary.

For example, the shape of the engaging portion 312 of the slider 31 may be changed as needed in correspondence with the shape of the blade 2.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

1. A folding knife comprising:
a handle;
a blade attached to the handle, the blade being capable of pivoting about a pivot axis defined in the handle, the blade being movable between a folded position, at which the blade is received in the handle, and an open position, at which the blade extends from the handle, the blade including a tang that is located in the handle when the blade is arranged at the open position;
a cam surface provided on an outer peripheral edge of the tang, the cam surface having a substantially arcuate guiding portion extending about the pivot axis and an engagement portion formed continuously from one end of the guiding portion;
a slider supported by the handle so as to be movable along the longitudinal direction of the handle, the slider including a manipulating portion projecting from the handle and an engaging portion engageable with the cam surface, the slider being movable between a lock position, at which the engaging portion is engaged with the engagement portion so as to lock the blade at the open position, and an unlock position, at which the engaging portion is spaced from the engagement portion to allow the blade to move from the open position; and
a bias member that biases the slider in a direction from the unlock position toward the lock position,
wherein the engaging portion of the slider has a pressing portion that is engaged with the blade when the blade is located at the folded position, the pressing portion pressing the blade out of the folded position toward the open position when the slider is moved in a direction from the lock position toward the unlock position with the blade held at the folded position.

2. The folding knife according to claim 1, wherein the pressing portion has a first pressing projection and a second pressing projection, and wherein the second pressing projection is arranged at a position more spaced from the pivot axis than the first pressing projection.

3. The folding knife according to claim 1, wherein the engaging portion of the slider includes a lock projection that is provided independently from the pressing portion and engageable with the cam surface.

4. The folding knife according to claim 1, wherein the slider includes a receiving hole that receives the bias member.

5. The folding knife according to claim 1, wherein the handle includes a spine, the spine including a finger guiding portion formed in the vicinity of the manipulating portion.

6. The folding knife according to claim 5, wherein the finger guiding portion has a recessed arcuate shape.

7. The folding knife according to claim 1, wherein the engagement portion is a first engagement portion formed continuously from one end of the guiding portion, wherein the cam surface further includes a second engagement portion formed continuously from the other end of the guiding portion, and wherein, when the blade is arranged at the folded position, the bias member biases the slider to press the engaging portion against the second engagement portion, thereby maintaining the blade at the folded position.

8. The folding knife according to claim 1, wherein the handle includes a pair of opposed sidewalls, wherein a receiving groove for receiving the blade is provided between the two sidewalls, and wherein the slider is located between the sidewalls.

9. A folding knife comprising:
a handle having a pair of opposed sidewalls, the handle having a distal portion, a basal portion, and a spine extending between the distal portion and the basal portion;
a blade shaft attached to the distal portion of the handle, the blade shaft having an axis extending across the handle;
a blade arranged between the two sidewalls and supported by the blade shaft so as to be capable of pivoting relative to the handle, the blade being movable between a folded position, at which the blade is received in the handle, and an open position, at which the blade extends from the handle, the blade including a tang that is located in the handle when the blade is arranged at the open position;
a cam surface provided on an outer peripheral edge of the tang, the cam surface having a substantially arcuate guiding portion extending about the axis of the blade shaft and an engagement portion formed continuously from one end of the guiding portion; and
a blade locking mechanism provided in the spine of the handle, the blade locking mechanism including:
a slider provided between the two sidewalls so as to be movable along a longitudinal direction of the handle, the slider including a receiving hole, a manipulating portion projecting from the spine, and a lock projection engageable with the cam surface, the slider being movable between a lock position, at which the lock projection is engaged with the engagement portion to lock the blade at the open position, and an unlock position, at which the lock projection is spaced from the engagement portion to allow the blade to move from the open position; and
a coil spring that is received in the receiving hole of the slider and biases the slider in a direction from
the unlock position toward the lock position,
wherein the slider further includes a pressing portion engaged with the blade when the blade is located at the folded position, and wherein, when the slider is moved from the lock position to the unlock position with the blade held at the folded position, the pressing portion presses the blade out of the folded position toward the open position.

10. The folding knife according to claim 9, wherein the pressing portion has a first pressing projection and a second pressing projection, the second pressing projection being located at a position more spaced from the pivot axis than the first pressing projection.

11. The folding knife according to claim 9, wherein the spine of the handle has a finger guiding portion arranged in the vicinity of the manipulating portion.

12. The folding knife according to claim 11, wherein the finger guiding portion has a recessed arcuate shape.
